(19) United States
(12) Patent Application Publication
(10) Pub. No.: US 2018/0263314 A1
(43) Pub. Date: Sep. 20, 2018

(54) Device And Method For Monitoring An Assembly Of Two Components To Be Connected By Means of A Clip Fastening

(71) Applicant: A. Raymond et Cie. SCS, Grenoble (FR)

(72) Inventors: Christian Fräulin, Waldkirch (DE); Michael Gemmp, Lörrach (DE); Tobias Buss, Kandern-Sitzenkirch (DE)

(73) Assignee: A. Raymond et Cie. SCS, Grenoble (FR)

(21) Appl. No.: 15/523,978

(22) PCT Filed: Nov. 2, 2015
(86) PCT No.: PCT/EP2015/002196

§ 371 Date: May 3, 2017

(30) Foreign Application Priority Data
Nov. 4, 2014 (DE) 10 2014 016 153.6

(51) Int. Cl. A41D 19/00; G01L 5/00; A41D 1/00

(52) U.S. Cl. CPC A41D 19/0027; F16B 2/20; A41D 1/002; G01L 5/0038

(57) ABSTRACT

Device and method suitable for monitoring an assembly of two components to be connected by means of a clip connection, wherein a sensor for detecting an assembly force and a sound receiver are present.

The invention relates to a device and a method for monitoring an assembly of two components to be connected by means of a clip fastening according to patent claim 1 and patent claim 7.

Various types of clip fastening are known for the detachable and non-detachable fastening of components. With a clip fastening or snap-in connection of this kind use is made of the elasticity of materials, mostly plastics or spring steel, in order to effect the connection of the two components. One of the two components comprises a clip/a joining part, which elastically deforms while forming the clip fastening and which subsequently locks detachably or non-detachably. This creates a form-lock. The two components are “clipped together”. Clip fastenings are used to a large extent in industrial mass production in the automobile sector and in the consumer goods industry. A clip fastening may be used, for example, in the automobile sector for attaching cladding parts, decorative trims, an air bag closure and door fillings. The DE 19939554A1 has disclosed a clip fastening for detachably attaching cladding to a column of a vehicle body, which describes an essentially U-shaped flexible clip at least in sections.

Frequently a clip for forming a clip fastening comprises at least a fastening sleeve with a clamping shank, wherein the fastening sleeve is connectable in the manner of a press button to e.g. a (counter) element in the form of a plug or socket pin. When two components are to be assembled, the fastening sleeve may be provided on one component and the plug may be provided on the other component. The assembly of two components by means of a clip fastening is frequently performed manually. Usually the plug locks, when an inherent assembly force for the clip fastening is overcome.

To monitor the assembly by means of a clip fastening the DE 103 08 403 B4 discloses that a sound signal generated during assembly of the component is to be detected with the aid of a sound sensor attached to a fitter in the region of his hand. The sound signal is subsequently converted into a measured signal, which is fed to an evaluation unit.

It has become evident that detection of the sound signal is very sensitive. Interferences may occur for example and monitoring of the assembly may become erroneous. Both a faulty forming of the clip fastening, which may cause inadvertent detachment, and the indication that a clip fastening was not properly assembled and needs further checking, leads to unnecessary operating steps, which are to be avoided.

It is therefore the requirement of the invention to propose a device and a method for monitoring an assembly of two components to be connected by means of a clip fastening, which is improved as regards the detection as to whether the clip fastening is locked.

The requirement is met by the subject of the ancillary patent claims. Further implementations are revealed in the description hereunder and in the sub-claims.

The core of the invention consists in that apart from detecting a sound signal provision is also made for a sensor for detecting an assembly force. By combining the information gained from the detected assembly force and the detected sound it is possible to improve monitoring of the assembly with a view to ensure that the clip fastening is securely locked.

According to the invention the term “assembly” encompasses a procedure in industrial manufacture, which comprises the systematic joining of structural parts, components and/or modules to form products or a modules of a higher product level. According to the invention any attempt at forming the clip fastening is understood to be an assembly. The term “assembly” therefore describes the procedure, but not a result so that it also encompasses that the manufacture of the clip fastening may be unsuccessful or insufficiently successful.

The indefinite article “a” including respective grammatical equivalents comprises, in particular as regards the sensor for detecting an assembly force and the sound receiver, the existence of exactly one of the elements as well as the existence of several of such elements. The number of sensors for detecting an assembly force and the number of sound receivers may be the same or different. Each sensor for detecting the assembly force may have a sound receiver associated with it.

The term “component” comprises, according to the invention, a structural part or a module, which shall be fastened by means of a clip fastening to another structural part or module.

The term “clip fastening”, according to the invention, comprises those connections which while creating the connection generate a discrete sound signal, particularly preferably a clicking sound. A discrete sound signal is understood to mean a sound signal, which particularly preferably as regards its acoustic level and the duration of its occurrence, is different from other sound signals during assembly, for example different from grinding noises which are created when the surfaces of the components to be connected rub against each other. A clip fastening, in particular, is understood to mean a so-called “quick connector”, in which a tube-shaped element is snapped into a holder. The term “clip fastening” also comprises a connector or other fixing element, which creates the discrete sound signal in forming the connection.

According to the invention the term “sound receiver” comprises a microphone, sensor or sound collector in which acoustic signals are converted into an electric voltage. Underlying conversion principles may be an electrodynamic, electrostatic, piezo-electric or piezo-resistive sound conversion.

According to the invention the term “sensor for detecting an assembly force” comprises a force transducer with which a force can be measured. Various implementations and operating principles for measuring the force in the force transducer are possible. Known force transducers are, for example, force transducers with a spring body, piezo-force transducers, force transducers with vibrating elements and force transducers with electromagnetic compensation.

The term “assembly force”, in terms of the invention, also comprises a force, where the application of that force is effected vertically to the assembly direction. For example, in order to form such a clip fastening, a hand of an operator performing the assembly may at least partially enclose a clip fastening/a component to be connected and comprising the clip fastening, and a rotation of the clip fastening and/or of the component comprising the clip fastening may be carried out. The “assembly force” may also be measured as a shearing force, which allows conclusions to be drawn as to the success of the assembly. In particular, using the above-mentioned force transducers, a force vertically to the assembly direction may be determined. A sensor for measuring a shearing/a shearing force may be configured as a piezo-force transducer. Such a piezo-force transducer may be implemented in an elongated or thread-like manner, wherein an expansion of the elongated or thread-like element allows to draw conclusions as to the assembly force. A shearing force may also be effected by means of a strain gauge or a sensor (miniaturised joystick), which emits a signal indicating the position of an inclinable body; the inclinable body, with one side, may be in direct or indirect contact or may be brought into contact with, the clip fastening and/or a component comprising the clip-fastening. The elongated or thread-like element for torsion measuring or equally a strain gauge may extend preferably at an angle smaller than 90°, in particular smaller than 50°, most particularly smaller than 45°, relative to the longitudinal extension of the hand. A small angle relative to the longitudinal extension of the hand may lead to a larger signal when subjected to the influence of a shearing force.

The term “elongated” or “thread-like”, in terms of the invention, comprises the formation of a thin and flexible sensor in comparison to a length.

Preferably the sensor for detecting an assembly force and/or the sound receiver are arranged on a glove, so that an operator performing the assembly can carry the device without much effort. A glove worn by the operator performing the assembly can be provided with the sensor for detecting an assembly force and with a sound receiver, according to the invention.

The term “glove” according to the invention comprises the piece of clothing, which covers the hand wholly or partially. The term glove also comprises an X-finger glove, wherein X fingers are at least partially covered, wherein X is a number smaller than 6. In terms of the invention the thumb of a hand is understood to be a finger. The at least partial covering of a finger may be present in the area of the fingertip and/or in a joint area of the finger and/or laterally on the finger.

Preferably the glove comprises at least one finger portion which at least partially surrounds a finger, wherein the sensor for detecting an assembly force is arranged in the area of the finger portion which surrounds the finger. In this way it can be ensured that the assembly force can be measured, as free from errors as possible, in the actual area, with which the user performs the assembly by means of the clip fastening. Preferably the sensor for detecting the assembly force is arranged on that side of the glove, which faces the inside of the finger of the hand of the operator. Provision may also be made for the sensor for detecting the assembly force to be arranged on the side of the glove, which faces the outside of the fingers of the hand of the operator. The location for attaching the sensor for detecting the assembly force is, in particular, chosen in dependence of the hand or finger movement, with which the user creates the clip fastening, in particular at the location of the expected flow of force from the hand of the user through the glove onto the component. One or more sensors for detecting the assembly force may be provided respectively for several fingers.

Preferably the finger portion is the portion of the thumb, wherein the sensor for detecting the assembly force is arranged in that area of the thumb portion, which surrounds at least partially the face of the tip of the thumb. In this way it is possible that the user assembling the clip fastening can use that finger of the hand for forming the clip fastening, with which a large force can be applied as free of fatigue as possible. The sensor for detecting the assembly force is preferably arranged on that side of the glove, which faces the inside of the thumb of the hand of the operator.

With a preferred embodiment the sensor for detecting the assembly force is arranged inside the glove so that the sensor for detecting the assembly force is protected by the surrounding glove and does not contact a surface which is exposed on the glove.

With a preferred embodiment the glove has a portion in which two finger portions, both provided for at least partially surrounding a finger, meet up with each other. The sound receiver is arranged in that portion, in which the two finger portions come together. The sound receiver is thus arranged in an area, which is not subjected to any mechanical pressure for performing the assembly of the clip fastening; the sound receiver is, however, still sufficiently close to the clip fastening to be formed. Due to the fact that the sound receiver is arranged in an area between two finger portions, the sound receiver is protected, even if the user performs, for example, an activity with his hand other than the assembly of the two components.

With a preferred embodiment the device is suitable for assembling two components which are to be connected by means of the clip connection.

With a preferred embodiment the device may comprise an acceleration sensor. Such an acceleration sensor, which preferably is also arranged on the glove of an operator performing the assembly, offers the advantage that the acceleration/movement of the operator can be ascertained and/or recorded on that portion, which is in contact with the sensor. Thus it may happen, for example, that determining the quality of forming the clip fastening is made more difficult because of a shielding of the clip or a low-noise sound signal (clicking sound), but conclusions as to quality of the assembly can still be drawn by means of an evaluation of the signal of an acceleration sensor. Using an acceleration sensor arranged on the glove on which the sound receiver and the sensor for detecting an assembly force are arranged, it is possible to determine the acceleration and also the movement of a hand or a finger. A correct or successful formation of a clip fastening may lead to a predefined acceleration behaviour or an acceleration signal of the acceleration sensor on the hand of the operator. A comparison of the predefined acceleration signal with the actual acceleration signal ascertained during the assembly may be used to draw conclusions as to the reliable assembly of the clip fastening. Depending on the type of clip fastening the signals of the sensor for detecting an assembly force, the sound receiver and the acceleration sensor can be combined with one another and correlated. For example, the signal of the sound receiver may be ignored if detection of a signal of the same does not play a significant role in the forming of a certain clip fastening.

The acceleration sensor may be arranged inside a glove on a finger, the back and/or the palm of the hand and may determine the acceleration of the finger, the back or the palm of the operator's hand.

The term “acceleration sensor” in terms of the invention, comprises an inertial sensor, with can be used for measuring accelerations. The acceleration sensor may be realised as a motion sensor, wherein acceleration sensors are easy and cheaply to obtain and to use. The term acceleration sensor may be used synonymously for each of the terms: motion sensor, acceleration sensor, accelerometer, B-meter or G-sensor.

The invention also proposes a method for monitoring an assembly of two components to be connected via a clip fastening, wherein the two components are brought together in order to perform the assembly by means of the clip fastening. During assembly of the two components, the force applied to at least one of the two components is measured by means of a device which is used for connecting the two components. Furthermore the sound generated during assembly of the two components is measured. Further, the method can be carried out with two or more devices in order to monitor, for example, a number of clip fastenings during assembly of the components, or to monitor an assembly of a clip fastening on both components.

Preferably, with the method, the progression of the measured force is recorded in dependence of time and/or the progression of the measured sound is recorded in dependence of time, which then offers the possibility of quality control of the assembly. The data can be recorded.

In order to ensure that the entire assembly process is monitored the data of the previous assembly process may be stored, while the current assembly process is performed by the operator. A stored time period possibly associated with the previous assembly process may for example also be associated with the current assembly process if a signal analysis reveals that the current signal is incomplete, e.g. the evaluation window has shifted. The length of the time slot for detecting the assembly process can be adapted and may, particularly preferably, lie in the range between 200 ms and 500 ms, preferably between 300 and 450 ms, particularly preferably between 350 and 420 ms.

Preferably the sensor for detecting an assembly force comprises a scanning frequency of 50 kHz over a time slot of 400 ms. Thus 20,000 scans are possible within the time slot.

Preferably, with the method, the progression of force is evaluated in dependence of time and/or the progression of sound is evaluated in dependence of time and a signal is generated, which indicates a quality of the assembly of the clip fastening, if the progression of force in dependence of time and/or the progression of sound in dependence of time matches one or more predefined criteria.

Possible criteria may constitute a detected local or absolute maximum of the assembly force, a detected local or absolute minimum of the assembly force, a detection of an assembly force plateau, evaluation of the progression of the determined assembly force in dependence of time (for example mathematical derivation including determining the gradient), detected local or absolute maximum of the sound, detected local or absolute minimum of the sound, detection of a plateau in the determined sound, evaluation of the progression of the determined sound in dependence of time (for example mathematical derivation including determining the gradient) and/or a correlation of the above-mentioned criteria.

With one preferred embodiment a criterion for a successful assembly, e.g. a secure locking of the clip fastening may be that the amplitude of the signal of the sound receiver exceeds a predefined threshold value.

With one preferred embodiment a criterion for a successful assembly, e.g. a secure locking of the clip fastening may consist in that the maximum of the sound signal (peak) does not reach or that it exceeds a predefined width.

With one preferred embodiment a criterion for a successful assembly, e.g. a secure locking of the clip fastening may consist in that a predetermined number of maxima of the sound signal is not exceeded within a time slot.

With one preferred embodiment a criterion for a successful assembly, e.g. a secure locking of the clip fastening may consist in that a correlation exists between the detected assembly force and the sound signal such that the detected assembly force, in terms of time, decreases nearer the maximum of the sound signal, forming for example a local minimum.

With one preferred embodiment a criterion for a successful assembly, e.g. a secure locking of the clip fastening may consist in that a local minimum of the assembly force exists, which is smaller than a predefined percentage value of the assembly force (for example 85%) prior to or after the peak of the sound signal.

With one preferred embodiment a criterion for a successful assembly, e.g. a secure locking of the clip fastening may consist in that the assembly force comprises a predefined value and/or a predefined rise before the sound signal determined for the assembly is determined.

With one preferred embodiment a criterion for a successful assembly, e.g. a secure locking of the clip fastening may consist in that the determined assembly force, even after detection of the sound signal determined for the assembly, lies on a level, which is higher than prior to the detection of the sound signal determined for the assembly.

In this way it is possible that different kinds of criteria, for example for different kinds of clip fastenings can be used, and that the method according to the invention can be applied to different clip fastenings.

With one preferred embodiment the signal generated by the sensor for detecting an assembly force and by the sound receiver is processed by means of a signal equaliser’ and/or a digital low-pass filter.

The invention will now be described in detail with reference to the exemplary embodiments shown in the drawings, in which

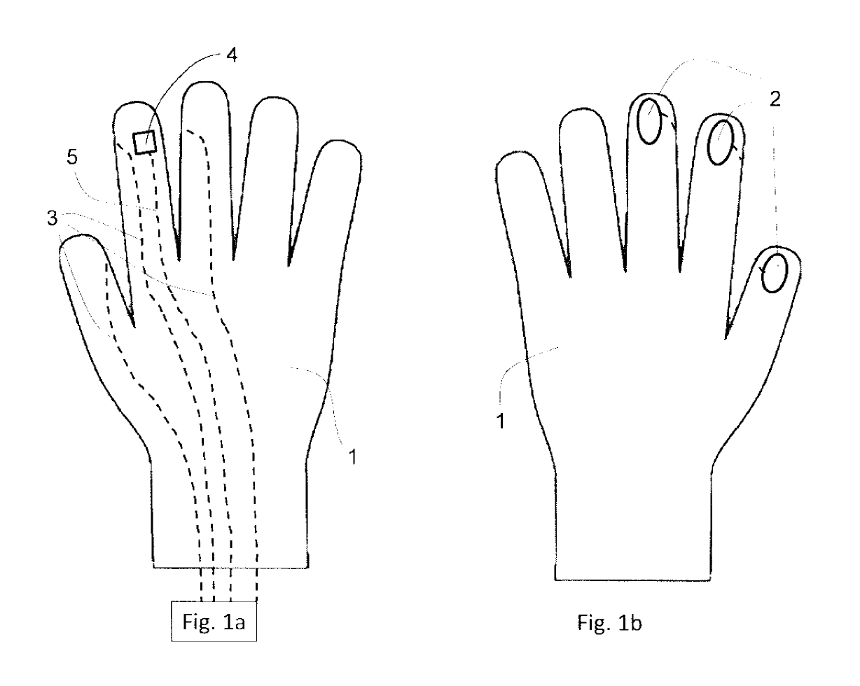

FIGS. 1a, 1b show a schematic drawing of a device according to the invention, and

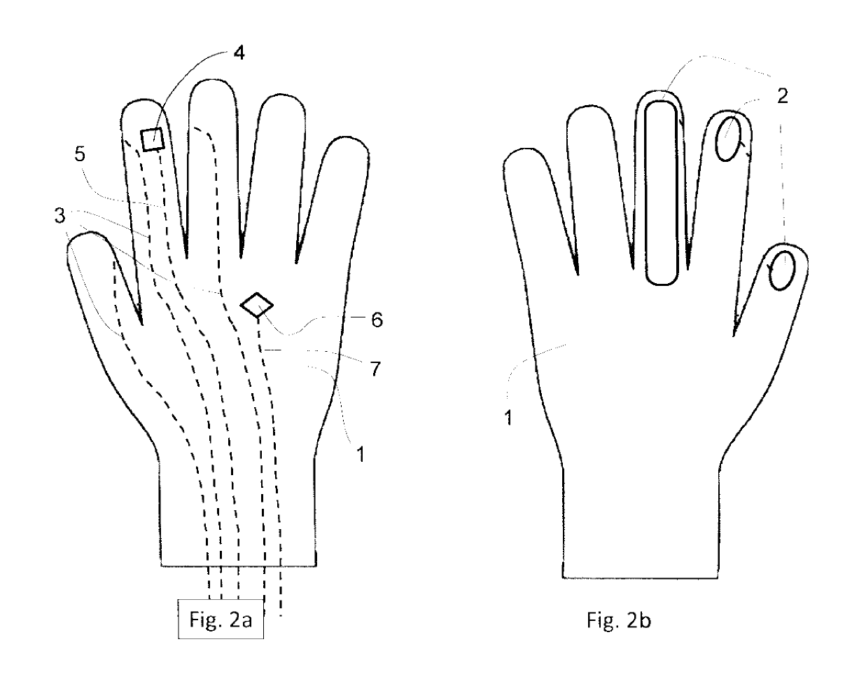

FIGS. 2a, 2b show a schematic drawing of the device according to the invention.

FIG. 1 shows a device which is suitable to monitor an assembly of two components to be connected by means of a clip fastening. Die device comprises a glove 1, wherein FIG. 1a shows the glove 1 in the area of the back of the hand, and FIG. 1b shows the glove 1 in the area of the palm. A sensor 2 for detecting an assembly force is arranged in the area of the thumb on the inside thereof. The signal generated by the sensor 2 for detecting an assembly force is passed, by means of a line 3, from the sensor 2 for the detecting an assembly force to a receiving unit. A sound receiver 4 is arranged on the outside surface in the area of the tip of the thumb or the index finger on the outside of the glove 1. The signal generated by the sound receiver 4 is fed to an evaluation unit by a line 5.

FIG. 2 shows a schematic view of the device according to the invention in a glove 1, in which sensors 2 for detecting an assembly force and a sound receiver 4 are arranged, wherein FIG. 2a shows the glove 1 in the area of the back of the hand and FIG. 2b shows the glove 1 in the area of the palm. The sensor 2 for detecting an assembly force, which is arranged on the middle finger, is configured as a thread-like piezo element and extends in longitudinal direction of the hand/the fingers of the hand. Using sensor 2, the assembly force can be determined in the form of a torsion or shearing force.

An acceleration sensor 6 is configured on the glove 1 in FIG. 2, the signal of which is fed to a receiving unit via a line 7. In the receiving unit the signal of the acceleration sensor can be evaluated. A correlation can be performed with the signal of the sensor 2 and/or the signal of the sound receiver 4.

1. A device suitable for monitoring the assembly of two components to be connected by means of a clip fastening, characterised by at least one sensor for detecting an assembly force and at least one sound receiver.

2. The device according to claim 1, characterised in that the sensor for detecting an assembly force and/or the sound receiver are arranged on a glove.

3. The device according to claim 2, characterised in that the glove has at least one finger portion which at least partially surrounds a finger and in that the sensor for detecting an assembly force is arranged in that are of the finger portion which at least partially surrounds the finger.

4. The device according to claim 3, characterised in that the finger portion surrounds the thumb at least partially and that the sensor for detecting an assembly force is arranged on the face of the tip of the finger portion for the thumb.

5. The device according to claim 2, characterised in that the sensor for detecting an assembly force is arranged within the glove.

6. The device according to claim 2, characterised in that the glove comprises a portion, in which two finger portions come together, which are both provided for surrounding a finger at least partially, and on which the sound receiver is arranged.

7. The device according to claim 1, characterised in that the device comprises an acceleration sensor.

8. A method for monitoring an assembly of two components to be connected by means of a clip fastening, wherein two components are brought together in order to perform the assembly by means of a clip fastening, characterised in that
during assembly of the two components the force applied upon at least one of the two components is measured by means of a device, which is used for connecting the two components, and
the sound, which is generated during assembly of the two components, is measured.

9. The method according to claim 8, characterised in that
the progression of the measured force is recorded in dependence of time and/or
the progression of the measured sound is recorded in dependence of time.

10. The method according to claim 9, characterised in that the progression of the force is evaluated in dependence of time and/or the progression of the sound is measured in dependence of time, and a signal is generated, which indicates a quality of the assembly of the clip fastening if the progression of the force in dependence of time and/or the progression of the sound in dependence of time matches a predefined criterion.

11. The method according to claim 8, characterised in that the acceleration of a finger and/or a hand of an operator performing the assembly is measured during assembly of the two components.

12. The method according to claim 8, characterised in that the device according to claim 1 is used to perform the method.

13. The device according to claim 3, characterised in that the sensor for detecting an assembly force is arranged within the glove.

14. The device according to claim 3, characterised in that the glove comprises a portion, in which two finger portions come together, which are both provided for surrounding a finger at least partially, and on which the sound receiver is arranged.

15. The device according to claim 2, characterised in that the device comprises an acceleration sensor.

16. The device according to claim 4, characterised in that the sensor for detecting an assembly force is arranged within the glove.

17. The device according to claim 4, characterised in that the glove comprises a portion, in which two finger portions come together, which are both provided for surrounding a finger at least partially, and on which the sound receiver is arranged.

18. The device according to claim 3, characterised in that the device comprises an acceleration sensor.

19. The method according to claim 9, characterised in that the acceleration of a finger and/or a hand of an operator performing the assembly is measured during assembly of the two components.

20. The method according to claim 9, characterised in that the device according to claim 2 is used to perform the method.
